(19) United States
(12) Patent Application Publication
(10) Pub. No.: US 2014/0126332 A1
(43) Pub. Date: May 8, 2014

(54) VERIFICATION OF WELL TOOL OPERATION WITH DISTRIBUTED ACOUSTIC SENSING SYSTEM

(71) Applicant: HALLIBURTON ENERGY SERVICES, INC., Houston, TX (US)

(72) Inventor: Neal G. SKINNER, Lewisville, TX (US)

(73) Assignee: HALLIBURTON ENERGY SERVICES, INC., Houston, TX (US)

(21) Appl. No.: 13/672,591

(22) Filed: Nov. 8, 2012

(51) Int. Cl. G01V 1/40; E21B 47/16

(52) U.S. Cl. CPC G01V 1/40; E21B 47/16
USPC 367/82; 367/81

(57) ABSTRACT

A system for use with a subterranean well can include a well tool which generates an acoustic signal in response to operation of the well tool, the acoustic signal being detected by an acoustic receiver in the well. A method for verification of operation of a well tool can include operating the well tool, thereby generating an acoustic signal, and an acoustic receiver receiving the acoustic signal generated by the well tool, the acoustic signal including information indicative of the well tool operating. Another system for use with a subterranean well can include a well tool which generates an acoustic signal in response to operation of the well tool, an optical waveguide which receives the acoustic signal, and an optical interrogator connected to the optical waveguide. The optical interrogator detects the acoustic signal, which is indicative of the well tool operation.

### BACKGROUND

This disclosure relates generally to equipment utilized and operations performed in conjunction with a subterranean well and, in one example described below, more particularly provides for verification of well tool operation using a distributed acoustic sensing (DAS) system.

It can be useful to monitor operation of well tools which are used with subterranean wells. For example, it can be difficult to obtain positive verification of whether or not a well tool has operated properly if there are no perceptible indications or other unambiguous indications that the well tool has operated.

For this purpose and others, it would be advantageous to provide advancements in the art of verifying operation of well tools.

### BRIEF DESCRIPTION OF THE DRAWINGS

FIG. 1 is a representative partially cross-sectional view of a well system and associated method which can embody principles of this disclosure.

FIG. 2 is a representative cross-sectional view of another example of the system and method.

### DETAILED DESCRIPTION

In one example described more fully below, a downhole well tool generates an acoustic signal when it operates. The acoustic signal can be detected by an optical fiber or other optical waveguide connected to a distributed acoustic sensing (DAS) instrument, for example, positioned at or near the earth's surface. With the use of a DAS instrument at the surface, normal, unmodified (usually single mode) optical fiber can be used as an acoustic receiver.

Some modifications to standard fiber can be made, if desired. For example, fiber Bragg gratings written in the fiber can allow the fiber to function as a distributed acoustic receiver for detecting acoustic waves which cause vibrations in the fiber. Additionally, standard fiber can be modified by writing or constructing intrinsic or extrinsic Fabry-Perot interferometers in the fiber.

If modified fiber is used, different types of instruments, designed to interrogate the various types of modified fiber may be used at the surface. Instruments used to interrogate multiple sensors distributed along modified fiber are well known in the art.

A DAS system example is described below, but it should be clearly understood that any type of distributed acoustic sensing system could benefit from the principles described herein. For example, in various different types of distributed acoustic sensing systems, backscattering of light in an optical waveguide may be used to detect acoustic signals (in which case the waveguide itself is an acoustic sensor), intrinsic or extrinsic Fabry-Perot interferometers may be used as acoustic sensors, intrinsic or extrinsic fiber Bragg gratings may be used as acoustic sensors, etc. The scope of this disclosure is not limited to use with any particular type of distributed acoustic sensing system.

One or more optical waveguides can be incorporated into a cable installed in a well. The cable can be positioned in cement surrounding a casing, between tubular strings, or in a wall of a tubular string, etc. The scope of this disclosure is not limited to any particular position of the optical waveguide(s) and/or cable.

When operated, the well tool generates acoustic signals, which cause minute changes in strain in the optical waveguide in response to acoustic waves impinging on the optical waveguide. These changes in strain are detected by the DAS instrument or other optical interrogator at the surface, where the presence of the acoustic signal is detected.

An actuator of the well tool may generate the acoustic signal when the well tool is actuated. Alternatively, or in addition, actuated components of the well tool (such as, a valve sliding sleeve or ball, a set of packer slips, detonation train components in a perforating assembly, etc.) may generate the acoustic signal.

The well tool could be conveyed in the well by, for example, jointed or continuous tubing, by slickline or wireline, etc. In some examples, the well tool could be permanently installed in the well.

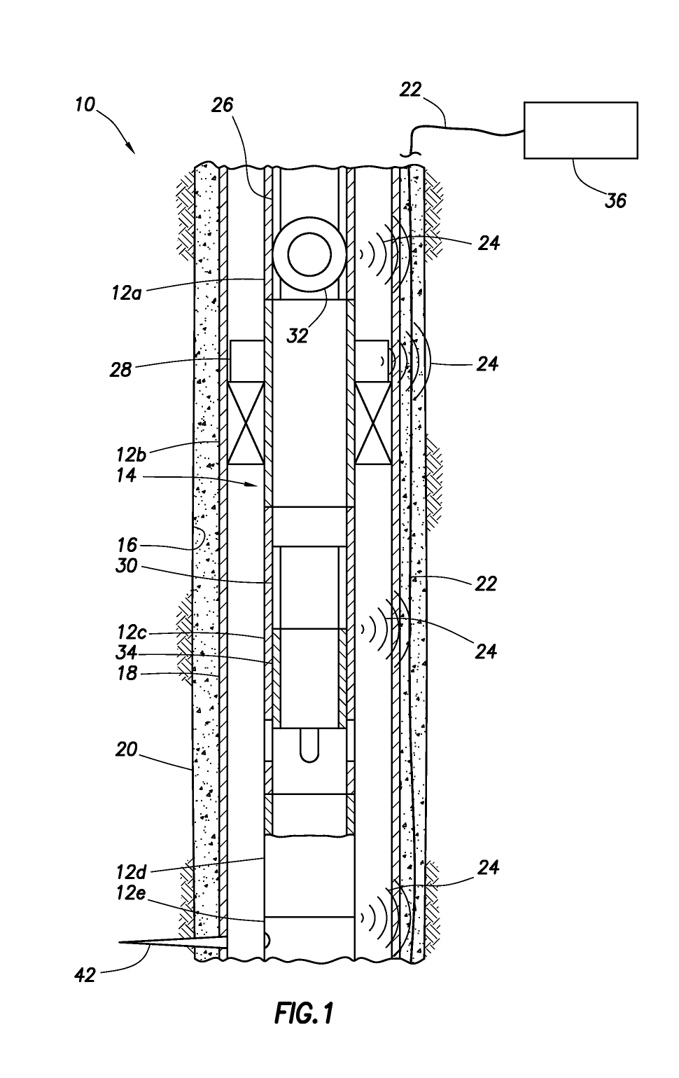

Representatively illustrated in FIG. 1 is a system 10 for use with a well, and an associated method, which system and method can embody principles of this disclosure. However, it should be clearly understood that the system 10 and method are merely one example of an application of the principles of this disclosure in practice, and a wide variety of other examples are possible. Therefore, the scope of this disclosure is not limited at all to the details of the system 10 and method described herein and/or depicted in the drawings.

In the FIG. 1 example, multiple well tools 12a-e are connected in a tubular string 14. The well tools 12a-e make up sections of the tubular string 14, but in other examples the well tools could be received in the tubular string, mounted external to the tubular string, or otherwise positioned.

The tubular string 14 is deployed in a wellbore 16 lined with a casing or other tubular string 18 and cement 20. In other examples, the wellbore 16 could be uncased or open hole.

The well tool 12a is depicted in FIG. 1 as a ball-type safety valve. An actuator 26 and/or a closure device 32 (e.g., a ball or flapper, etc.) of the safety valve can generate an acoustic signal 24 which indicates that the safety valve is operated to its open or closed configuration.

The well tool 12b is depicted in FIG. 1 as a packer. An actuator 28 or another component (e.g., a set of slips, etc.) of the packer can generate an acoustic signal 24 which indicates that the packer is set or unset.

The well tool 12c is depicted in FIG. 1 as a sliding sleeve-type flow control device which controls flow of fluid into or out of the tubular string 14. An actuator 30 or another component (e.g., a closure device 34, etc.) can generate an acoustic signal 24 which indicates that the flow control device is opened, closed, or in a choked flow configuration.

The well tool 12d is depicted in FIG. 1 as a firing head of a perforating assembly. The firing head, or another well tool 12e depicted in FIG. 1 as a perforating gun, can generate an acoustic signal 24 which indicates that the firing head has been operated, and/or that the perforating gun has fired and formed one or more perforations 42 through the tubular string 18 and cement 20.

The well tools 12a-e are depicted in FIG. 1 merely as examples of a wide variety of different well tools which can utilize the principles of this disclosure. Other types of well tools can also, or alternatively, generate the acoustic signal 24 when the well tools are operated. Some other examples of well tools include blowout preventers, chemical or other fluid injection equipment, subsea test trees, etc. The scope of this disclosure is not limited to use with any particular type of well tool.

Note that the acoustic signal 24 is preferably not the same for each of the well tools 12a-e. Differences in the acoustic signals 24 can be useful for determining which well tool has operated, and how that well tool has been operated (e.g., opened, closed, set, unset, etc.).

Most downhole tools generally generate metallic sounds that may be described informally as clanks, clicks, bangs, etc., when actuated. These sounds are generated usually without any intentional or additional modifications. If desired, downhole tools may be modified with additional components, such as bells, ratchets or other simple, inexpensive noise generating devices, in order to enhance acoustic emissions generated upon actuation.

The acoustic signal 24 can be indicative of whether the well tool 12a-e has properly operated. For example, sounds resulting from fluid leakage into or out of a well tool 12a-e can indicate that the well tool is not sealing, an actuator of the well tool is not functioning properly, etc.

An optical waveguide 22 (such as, an optical fiber, an optical ribbon, etc.) is positioned in the cement 20 external to the tubular string 18. In other examples, the optical waveguide 22 could be positioned internal to the tubular string 18, in a wall of the tubular string 18, etc.

In some examples, the optical waveguide 22 could be positioned in the tubular string 14, in a wall of the tubular string 14, between the tubular strings 14, 18, etc. If the optical waveguide 22 is positioned inside the tubular string 14, the optical waveguide may be conveniently installable into and retrievable from the tubular string, e.g., as part of a retrievable cable.

The optical waveguide 22 serves as an acoustic receiver for receiving acoustic signals 24 transmitted from any of the well tools 12a-e. The acoustic signals 24 cause vibrations, including variations in strain, in the optical fiber 22. An optical interrogator 36 connected to the optical waveguide 22 detects variations in light as transmitted through the optical waveguide due to the vibrations, and thereby detects the presence (or lack of) the acoustic signal 24.

In a DAS system, the interrogator 36 may launch pulses of light into the optical waveguide 22 and detect backscattering of light (e.g., coherent Rayleigh backscattering) through the optical waveguide. In an interferometric or fiber Bragg grating systems, the interrogator 36 may detect variations in reflected amplitude and or phase of reflected light (e.g., from fiber Bragg gratings, etc.) through the optical waveguide 22, in order to detect the acoustic waves 24. Alternatively, if the fiber is in the form of a loop that travels from the surface, into the well and back to the surface, i.e., if both ends of the fiber are accessible at the surface, changes in amplitude and or phase of transmitted light may also be used to interrogate the system.

Note that the optical waveguide 22 is available to receive the acoustic signals 24 at any location in the wellbore 16 where the optical waveguide is present (or at least proximate). Thus, the well tools 12a-e or other well tools can be positioned in other locations, and retain the ability to transmit the acoustic signal 24 to the optical waveguide 22.

If the optical waveguide 22 is retrievably installed in the tubular string 14 (e.g., as part of a cable, in coiled tubing, etc.), then the optical waveguide can detect acoustic signals 24 emitted from, for example, a leaking or otherwise malfunctioning well tool (such as a leaking gas lift mandrel, etc.). A pulling tool conveyed with the optical waveguide 22 could be used to retrieve a leaking gas lift valve detected by the optical waveguide. A separate run could be used to install a replacement or repaired gas lift valve.

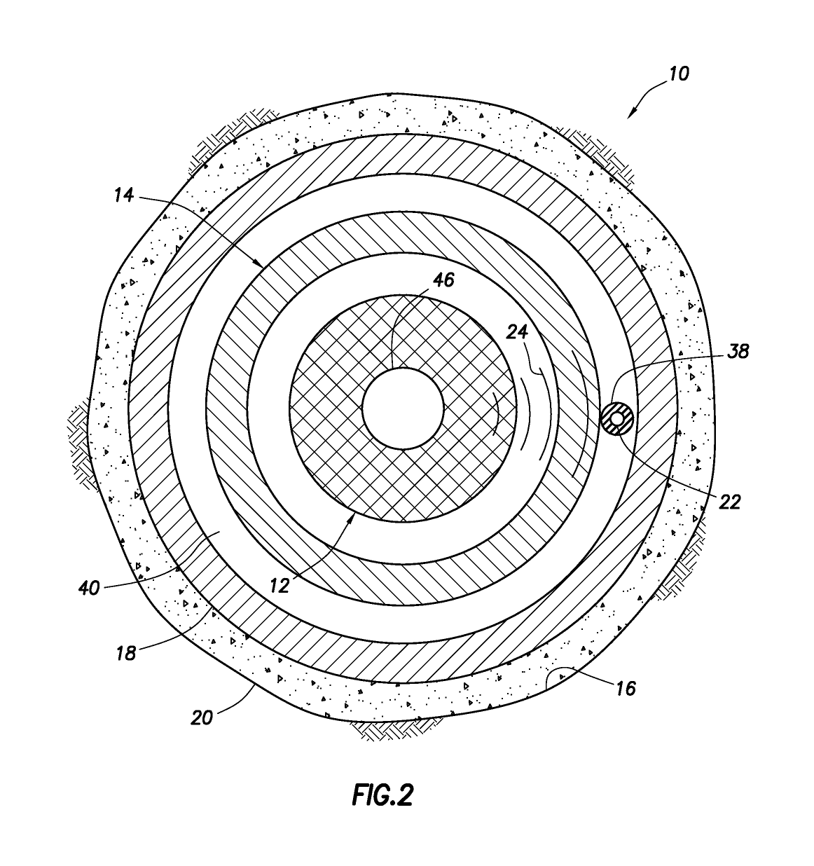

Referring additionally now to FIG. 2, another configuration of the system 10 is representatively illustrated in a lateral cross-sectional view. In this view, it may be seen that the optical waveguide 22 is included as part of a cable 38 in an annulus 40 formed radially between the tubular strings 14, 18. In some examples, the cable 38 could be attached to an exterior of the tubular string 14, or could be retrievably installed in the tubular string 14.

A well tool 12 is positioned in an interior of the tubular string 14. For example, the well tool 12 could be conveyed by wireline, slickline, coiled tubing, etc., into the tubular string.

At least one component 46 of the well tool 12 generates the acoustic signal 24 when the well tool is operated. The acoustic signal 24 travels through the tubular string 14 to the optical waveguide 22 in the cable 38. In other examples, the cable 38 could be inside the tubular string 14, or in a wall of the tubular string.

It may now be fully appreciated that the above disclosure provides significant advancements to the art of verifying operation of well tools. In one example, operation of a well tool 12a-e can be verified by detecting an acoustic signal 24 indicative of the well tool operation. An optical waveguide 22 may be installed in the well for this verification purpose, or an existing optical waveguide may be utilized for this purpose, for example, by connecting a suitable optical interrogator 36 to the existing optical waveguide.

A system 10 for use with a subterranean well is provided to the art by the above description. In one example, the system 10 can include a well tool 12a-e which generates an acoustic signal 24 in response to operation of the well tool 12a-e. The acoustic signal 24 is detected by an optical waveguide 22, with the optical waveguide 22 comprising an acoustic receiver. In other examples, the acoustic receiver can comprise one or more Fabry-Perot interferometers and/or fiber Bragg gratings.

An actuator 26, 28, 30 or another component 46 of the well tool 12a-e may generate the acoustic signal 24. The acoustic signal 24 may cause vibrations in the optical waveguide 22.

An optical interrogator 36 connected to the optical waveguide 22 can detect backscattering of light in the optical waveguide 22. The backscattering of light may be indicative of vibrations distributed along the optical waveguide 22.

The well tool 12a-e can be connected in a tubular string 14. The optical waveguide 22 or other acoustic receiver may be positioned external or internal to the tubular string 14.

The optical waveguide 22 may be positioned between tubular strings 14, 18. The optical waveguide 22 may be positioned in cement 20 external to a tubular string 18.

A method for verification of operation of a well tool 12a-e is also described above. In one example, the method can comprise: operating the well tool 12a-e, thereby generating an acoustic signal 24; and an optical waveguide 22 or other acoustic receiver receiving the acoustic signal 24 generated by the well tool 12a-e, the acoustic signal 24 including information indicative of the well tool 12a-e operating.

The method can comprise positioning the optical waveguide 22 or other acoustic receiver and the well tool 12a-e in a wellbore 16. In other examples, the well tool 12a-e and optical waveguide 22 may not be positioned in a wellbore (e.g., a blowout preventer stack at a subsea location, etc.).

A system 10 for use with a subterranean well is described above. In one example, the system 10 can include a well tool 12a-e which generates an acoustic signal 24 in response to operation of the well tool 12a-e, an optical waveguide 22 which receives the acoustic signal 24, and an optical interrogator 36 connected to the optical waveguide 22. The optical interrogator 36 detects the acoustic signal 24 which is indicative of the well tool 12a-e operation.

Although various examples have been described above, with each example having certain features, it should be understood that it is not necessary for a particular feature of one example to be used exclusively with that example. Instead, any of the features described above and/or depicted in the drawings can be combined with any of the examples, in addition to or in substitution for any of the other features of those examples. One example's features are not mutually exclusive to another example's features. Instead, the scope of this disclosure encompasses any combination of any of the features.

Although each example described above includes a certain combination of features, it should be understood that it is not necessary for all features of an example to be used. Instead, any of the features described above can be used, without any other particular feature or features also being used.

It should be understood that the various embodiments described herein may be utilized in various orientations, such as inclined, inverted, horizontal, vertical, etc., and in various configurations, without departing from the principles of this disclosure. The embodiments are described merely as examples of useful applications of the principles of the disclosure, which is not limited to any specific details of these embodiments.

In the above description of the representative examples, directional terms (such as “above,” “below,” “upper,” “lower,” etc.) are used for convenience in referring to the accompanying drawings. However, it should be clearly understood that the scope of this disclosure is not limited to any particular directions described herein.

The terms “including,” “includes,” “comprising,” “comprises,” and similar terms are used in a non-limiting sense in this specification. For example, if a system, method, apparatus, device, etc., is described as “including” a certain feature or element, the system, method, apparatus, device, etc., can include that feature or element, and can also include other features or elements. Similarly, the term “comprises” is considered to mean “comprises, but is not limited to.”

Of course, a person skilled in the art would, upon a careful consideration of the above description of representative embodiments of the disclosure, readily appreciate that many modifications, additions, substitutions, deletions, and other changes may be made to the specific embodiments, and such changes are contemplated by the principles of this disclosure. For example, structures disclosed as being separately formed can, in other examples, be integrally formed and vice versa. Accordingly, the foregoing detailed description is to be clearly understood as being given by way of illustration and example only, the spirit and scope of the invention being limited solely by the appended claims and their equivalents.

What is claimed is:

1. A system for use with a subterranean well, the system comprising:
a well tool which generates an acoustic signal in response to operation of the well tool, the acoustic signal being detected by an acoustic receiver in the well.

2. The system of claim 1, wherein an actuator of the well tool generates the acoustic signal.

3. The system of claim 1, wherein the acoustic signal is indicative of fluid leakage.

4. The system of claim 1, wherein the acoustic receiver comprises an optical waveguide.

5. The system of claim 4, wherein the acoustic signal causes vibrations in the optical waveguide.

6. The system of claim 4, wherein an optical interrogator connected to the optical waveguide detects backscattering of light in the optical waveguide.

7. The system of claim 6, wherein the backscattering of light is indicative of vibrations distributed along the optical waveguide.

8. The system of claim 1, wherein the acoustic receiver comprises a fiber Bragg grating.

9. The system of claim 1, wherein the acoustic receiver comprises a Fabry-Perot interferometer.

10. The system of claim 1, wherein the well tool is connected in a tubular string.

11. The system of claim 10, wherein the acoustic receiver is positioned external to the tubular string.

12. The system of claim 10, wherein the acoustic receiver is positioned internal to the tubular string.

13. The system of claim 1, wherein the acoustic receiver is positioned between tubular strings.

14. The system of claim 1, wherein the acoustic receiver is positioned in cement external to a tubular string.

15. A method for verification of operation of a well tool, the method comprising:
operating the well tool, thereby generating an acoustic signal; and
an acoustic receiver receiving the acoustic signal generated by the well tool, the acoustic signal including information indicative of the well tool operating.

16. The method of claim 15, wherein the acoustic signal is indicative of fluid leakage.

17. The method of claim 15, wherein the acoustic receiver comprises an optical waveguide.

18. The method of claim 17, further comprising the acoustic signal causing vibrations in the optical waveguide.

19. The method of claim 17, further comprising an optical interrogator connected to the optical waveguide detecting backscattering of light in the optical waveguide.

20. The method of claim 19, wherein the backscattering of light is indicative of vibrations distributed along the optical waveguide.

21. The method of claim 15, wherein the acoustic receiver comprises a fiber Bragg grating.

22. The method of claim 15, wherein the acoustic receiver comprises a Fabry-Perot interferometer.

23. The method of claim 15, wherein the well tool is connected in a tubular string.

24. The method of claim 23, wherein the acoustic receiver is positioned external to the tubular string.

25. The method of claim 23, wherein the acoustic receiver is positioned internal to the tubular string.

26. The method of claim 15, wherein the acoustic receiver is positioned between tubular strings.

27. The method of claim 15, wherein the acoustic receiver is positioned in cement external to a tubular string.

28. The method of claim 15, further comprising positioning the acoustic receiver and the well tool in a wellbore.

29. A system for use with a subterranean well, the system comprising:
a well tool which generates an acoustic signal in response to operation of the well tool, the acoustic signal being detected by an optical waveguide, the optical waveguide comprising an acoustic receiver.

30. The system of claim 29, wherein an actuator of the well tool generates the acoustic signal.

31. The system of claim 29, wherein the acoustic signal is indicative of fluid leakage.

32. The system of claim 29, wherein the acoustic signal causes vibrations in the optical waveguide.

33. The system of claim 29, wherein an optical interrogator connected to the optical waveguide detects backscattering of light in the optical waveguide.

34. The system of claim 33, wherein the backscattering of light is indicative of vibrations distributed along the optical waveguide.

35. The system of claim 29, wherein the well tool is connected in a tubular string.

36. The system of claim 35, wherein the optical waveguide is positioned external to the tubular string.

37. The system of claim 29, wherein the optical waveguide is positioned between tubular strings.

38. The system of claim 29, wherein the optical waveguide is positioned in cement external to a tubular string.
